(19) United States
(12) Patent Application Publication
(10) Pub. No.: US 2015/0094251 A1
(43) Pub. Date: Apr. 2, 2015

(54) DILUTABLE GEL CLEANING CONCENTRATES

(71) Applicant: S.C. Johnson & Son, Inc., Racine, WI (US)

(72) Inventors: Wayne M. REES, Racine, WI (US); Thomas A. STRASH, Kenosha, WI (US)

(73) Assignee: S. C. JOHNSON & SON, INC., Racine, WI (US)

(21) Appl. No.: 14/495,618

(22) Filed: Sep. 24, 2014

Related U.S. Application Data
(60) Provisional application No. 61/883,721, filed on Sep. 27, 2013.

(51) Int. Cl. C11D 17/00

(52) U.S. Cl. CPC C11D 17/0026
USPC 510/403; 510/405

(57) ABSTRACT

A dilutable cleaner gel concentrate, dilutable cleaner gel concentrate in combination with a dispensing package, and method of using the cleaner gel concentrate are described. The gel concentrate includes a surfactant system which provides the concentrate having a gel point that allows the gel concentrate to convert from a highly viscous “stiff” gel at room temperature to a thin low viscosity liquid, that when combined with warm or hot water, the thin liquid readily mixes to provide an aqueous solution in which the liquid concentrate and water are uniformly dispersed. The viscosity of the gel at room temperature is about 50 to about 5000 Pa-s. The gel concentrate can be packaged in a squeezable dispenser. The gel concentrate is sufficiently shear thinning to allow it to flow from the dispenser upon mild manual pressure. The primary surfactant(s) of the surfactant system is(are) highly ethoxylated alcohol ethers and highly polyethoxylated alcohols.

### RELATED APPLICATION

The present application claims benefit of U.S. Provisional Application Ser. No. 61/883,721 filed Sep. 27, 2013 entitled “DILUTABLE GEL CLEANING CONCENTRATES”.

### FIELD OF INVENTION

The invention is directed to a dilutable cleaner concentrate composition and a method of using the cleaner concentrate composition. The concentrate is in the form of a highly viscous or “stiff” gel and is readily dilutable in water having a temperature equal to or greater than the gel temperature of the concentrate to provide an aqueous cleaning solution. The cleaning solution is primarily suited for cleaning soils from household surfaces.

### BACKGROUND OF THE INVENTION

Cleaner concentrates in the form of a low viscosity liquid or pourable viscous liquid are known in the art. Such liquid concentrates when used are generally poured into a water-containing bucket wherein the liquid concentrate is diluted to provide a cleaning solution applied by a mop, sponge or other applicator to a surface to be cleaned. A problem with such liquid concentrates is that measuring out of an appropriate amount of the liquid cleaner is required. Generally, the cap of the container from which the cleaner concentrate is dispensed is used which requires an extra step, as well as often causing a mess through dripping of the concentrate liquid from the cap onto the container and/or bucket and/or user. If a measuring aid is not utilized, then either a too dilute or weak solution may be provided or a too strong solution, the latter then also resulting in waste of the concentrate. Further, liquid concentrates are conventionally packaged in medium to large heavy plastic containers which can be heavy or awkward to carry, require significant storage space during non-use, and also provide for waste that can be detrimental to the environment in the event the containers are not recyclable in a community or are not recycled by the user.

Gel cleaning concentrates are also known in the art. However, gel cleaning concentrates are either not intended for complete dissolution upon contact with water so as to be useful in place over a period of time, or to the extent they are intended to be completely dissolved in water for immediate use, such are not readily soluble in water and require extra mixing time and action on the part of the user.

The invention addresses the above concerns by providing a cleaner gel concentrate that does not require a separate measuring aid due to its physical structure, does not require extensive mixing action when combined with warm or hot water, and which is packagable in smaller dispensing containers to provide easier transport, storage and a smaller ecological footprint in the event the dispensing container is not recycled.

### SUMMARY OF INVENTION

A dilutable cleaner gel concentrate composition, a cleaning concentrate product including a dilutable cleaner gel concentrate composition in combination with a dispensing package, and method of using the cleaner gel concentrate composition are described which overcome the disadvantages of the prior art.

The dilutable cleaner gel concentrate includes a surfactant system which is the basis of the gelling system providing the concentrate as a highly viscous or “stiff” gel which readily converts to a thin or low viscosity liquid when mixed with a quantity of water having a temperature equal to or greater than the “gel temperature” of the concentrate, preferably warm or hot water.

Further, the cleaner concentrate in the form of a “stiff” but dispensable gel is combined with a user-friendly dispensing package, preferably a soft-wall or squeeze-type dispensing package, preferably collapsible.

The gel rheology of the dilutable cleaner concentrate composition is engineered so that the gel concentrate composition can be easily dispensed from a dispensing package, e.g., by squeezing with 1 or 2 hands to manually apply pressure to exterior side walls of the package. The gel concentrate has a “gel temperature” or gel point that allows the highly viscous gel concentrate to convert to a thin (low viscosity) liquid when placed in water having a temperature above room temperature, preferably moderately warm or hot water, more preferably having a water temperature of about 35° C. (95° F.) or greater, and more preferably a temperature in a range of about 40 to about 50° C. (104-122° F.). Thus, when the stiff gel concentrate converts to a thin liquid in warm/hot water, the concentrate mixes easily, quickly, and completely with the water to provide an aqueous-based cleaning solution in which both the liquid concentrate and water are uniformly dispersed. When packaged, and dispensed by a user, the gel concentrate has a stiff appearance and retains its shape under the influence of gravity, i.e., it does not significantly flow or “creep”, connoting to the user that the gel is a highly concentrated cleaner and providing the concentrate with a workable or controllable physical compositional structure. Thus, the “stiff” gel concentrate will dispense cleanly, without splashing or spilling or running on the outside of the dispensing container, unlike thin liquids and mildly viscous liquid concentrates. Additionally, due to the gel concentrate's shape retention based on the highly viscous physical structure of the gel concentrate, measurement of the amount of cleaner concentrate to be used is visually determinable and controllable and is not required to be measured into a cap or other measuring aid.

The gel concentrate composition contains a surfactant system including a major amount of a primary surfactant, preferably about 10 to about 50 wt. %, more preferably about 15 to about 30 wt. %. The primary surfactant forms or is part of the gelling system, as well as a cleaning component of the composition. The amount of primary surfactant insures that when the gel concentrate is diluted in a large amount of water, the diluted cleaner composition retains effective cleaning properties as to various household soils and also provides visible foaming which serves as a cue to the user to indicate cleaning. The gel concentrate may also contain a lesser amount of secondary surfactant(s), as well as minor amounts of adjuvant cleaning ingredients, such as acidic or alkaline agents, enzymes, detergency builders, bleaching agents, cleaning solvents, salts, biocidal agents, fragrance oils and preservatives, as needed or desired for good cleaning performance and/or stability. Further, preferably, the gel concentrate is clear or transparent, not opaque. However, the gel may contain dyes or other colorants, or visible particles to provide a pleasing aesthetic effect.

The gel concentrate is highly viscous at room temperature, i.e., about 50 to about 5000 Pascal-second (Pa-s) (50,000-5,000,000 centipoise (cP)) under low shear conditions at approximately 25° C. The gel concentrate should be sufficiently shear thinning so that the gel concentrate flows from a storage/dispensing package when mild pressure, such as squeezing by hand, is applied to the exterior of the package.

As stated above, the surfactant system of the gel concentrate composition forms the basis for the gelling system. The gel concentrate should possess a gel point (i.e., the temperature at which the stiff, highly viscous gel transitions to a thin, relatively non-viscous liquid) which is above room temperature and preferably is in a range of about 35 to about 55° C., more preferably in a range of about 40 to about 50° C., and most preferably in a range of about 40 to about 45° C., so that the gel concentrate easily and readily dissolves/mixes/dilutes in water upon addition to or placement in water having a temperature equal to or greater than the gel temperature of the concentrate, preferably moderately warm to hot water.

### DETAILED DESCRIPTION OF THE INVENTION

A dilutable high viscosity cleaner concentrate in gel form is described comprising
(1) about 10 to about 50 wt. % of at least one primary surfactant of an ethoxylated alcohol ether and/or polyethoxylated alcohol, RO(CH₂CH₂O)ₓH, wherein the alkyl radical R═C_{y}H_{2y+1} (where y≧10) or R=an oleyl radical (C₁₈H₃₅) and x is equal to or greater than about 15;
(2) 0 to about 15 wt. % of at least one secondary surfactant comprising one or more of an anionic, nonionic, cationic, zwitterionic and/or amphoteric surfactant, in particular preferably one or more of an alcohol ethoxylate which is different from the primary surfactant described in (1) above, an alkyl aryl sulfonate, alkyl sulfonate, alkyl sulfate, alkyl ether sulfate, and alkyl dimethyl amine oxide;
(3) 0 to about 5 wt. % of a rheology modifying agent different from (1) and (2) above;
(4) 0 to about 10 wt. % fragrance(s);
(5) 0 to about 5 wt. % acid(s);
(6) 0 to about 5 wt. % alkaline agent(s);
(7) 0 to about 5 wt. % antimicrobial agent(s);
(8) 0 to about 0.1 wt. % water-soluble dye(s);
(9) 0 to about 1 wt. % preservative agent(s);
(10) 0 to about 5 wt. % bleaching agent(s);
(11) 0 to about 5 wt. % detergency builder(s);
(12) 0 to about 5 wt. % cleaning solvent(s);
(13) 0 to about 5 wt. % a salt or salt(s);
(14) 0 to about 1 wt. % enzyme(s); and
(15) a balance of water;

wherein the gel concentrate has a viscosity of about 50,000 to about 5,000,000 centipoise (cP) at approximately 25° C.;

wherein the gel primary surfactant(s) and the said secondary surfactant(s) provide a surfactant system providing the gel concentrate with a gel point preferably in a range of about 35° C. to about 55° C.

Another embodiment is of a cleaning concentrate product including the dilutable gel cleaner concentrate as described above and a soft-walled or squeezable dispensing package, preferably collapsible, containing the dilutable cleaning concentrate wherein the gel concentrate is sufficiently shear thinning to flow from the package upon manual pressure to exterior walls of the package or dissolution of the walls of the package.

A method of preparing a cleaning solution from the dilutable cleaner concentrate in gel form as described above comprises (a) providing the dilutable cleaner concentrate in gel form and (b) combining the cleaner concentrate in gel form and a quantity of water, wherein the water is at a temperature equal to or greater than the gel temperature of the concentrate and is sufficient in quantity and temperature to convert the cleaner concentrate from the high viscosity of the gel concentrate to a thin, low viscosity [i.e., less than or equal to about 1 Pa-s (1000 cP)] liquid which mixes easily with the water to provide an aqueous cleaning solution in which the liquid concentrate and water are uniformly dispersed. A preferred dilution ratio of gel concentrate to water is about 1:10 to about 1:2000 based on wt. %.

The dilutable high viscosity cleaner gel concentrate is a “stiff” but dispensable gel which for use is preferably combined with a user-friendly dispensing package, such as for example a soft-walled squeeze-type or water-soluble single use pouch package. The gel rheology of the cleaner gel concentrate is engineered so that the cleaner concentrate can be easily dispensed from the package, e.g., squeezing with 1 or 2 hands to manually apply pressure to exterior walls of the package. The highly viscous gel concentrate has a “gel temperature” or gel point such that the gel concentrate converts to a thin liquid in water having a temperature above room temperature, preferably moderately warm or hot water, more specifically preferably water temperatures of about 35° C. (95° F.) or greater, and yet more preferably temperatures in a range of about 40 to about 50° C. (104-122° F.). Thus, when the stiff high viscosity gel concentrate converts to a thin low viscosity liquid in water with a temperature at or above the gel point, in particular warm or hot water, the liquid concentrate mixes easily, quickly, and completely with the water to form an aqueous-based cleaning solution. The cleaning solution can then be used in a conventional manner, e.g., application to a surface using a sponge, mop, towel or the like.

In the package, and when dispensed by the user, the gel concentrate has a stiff appearance, i.e., the gel concentrate retains its shape under the influence of gravity and does not significantly flow or “creep”, connoting to a user that the gel is a highly concentrated cleaner. Additionally, the “stiff” gel concentrate dispenses cleanly, without splashing or spilling or running on the outside of a dispensing container, unlike thin liquid and mildly viscous liquid cleaning concentrates. This physical structure of the gel concentrate also allows the dispersing of the gel concentrate to be neat and visually controlled, i.e., without the need for a separate measuring aid.

The high viscosity gel concentrate includes a surfactant system which is the basis of the gelling system. The surfactant system includes a major amount of at least one primary surfactant, preferably about 10 to about 50 wt. % (it being understood that the total gel concentrate composition is based on 100 wt. %), more preferably about 15 to about 30 wt. %, such that when the cleaner gel concentrate is diluted in a large amount of water, the diluted composition retains effective cleaning properties as to various household soils and also provides a visible “foaming” cue to the user to indicate cleaning action. The surfactant(s) (whether primary or secondary surfactants) of the surfactant system preferably have a good eco-toxicology profile so the concentrate is relatively non-hazardous to a user and is not harmful to the environment. Preferably, the primary or major surfactant component(s) is/are one or more highly ethoxylated fatty alcohol ether or polyethoxylated alcohol, RO(CH₂CH₂O)ₓH nonionic surfactant. The surfactants of the surfactant system are further described below.

The dilutable cleaner gel concentrate is highly viscous at room temperature, i.e., about 50 to about 5000 Pa-s, (50,000-5,000,000 cP) under low shear conditions, at approximately 25° C. The gel concentrate should be significantly shear thinning so that the concentrate flows from a dispensing package, for example under application of mild pressure, such as manual squeezing by hand.

The gel concentrate, preferably, is “clear” (transparent), not opaque or semi-opaque, which is further appealing to a user. However, the gel may contain dyes or other colorants, or visible particles for an alternative pleasing aesthetic effect.

Preferably, the gel concentrate is packaged in a clear (transparent) package, so that the user can see the product within. A preferred form of packaging is a clear or semi-transparent flexible tube-type package with one or more dispensing orifices and a cap. Alternative packaging forms may also be desirable such as low cost single use pouches or plastic vials. Preferably, the dispensing package is easily collapsible when squeezed by hand. The gel concentrate is preferably tinted by using a dye.

Additionally, preferably, the gel is fragranced. Most preferably, the gel will contain a significant amount of fragrance, about 1% or more, so that a user can clearly detect the presence of fragrance when the gel concentrate is diluted in a large quantity of water. An approximate gel concentrate to water dilution ratio is about 1/10 to about 1/2000 by weight %. The dilutable gel concentrate preferably has a high fragrance content of about 1 to about 10 wt. % when fragrance is included in the concentrate.

The gel concentrate may also include minor amounts of one or more adjuvant cleaning ingredients, such as acid or alkaline agent(s), enzyme(s), detergency builder(s), solvent(s), biocidal agent(s), bleaching agent(s), salt(s), rheology-modifying agent(s), and preservative(s), as needed or desired to provide for a good cleaning performance and/or stability.

The high viscosity gel concentrates have a gel point (i.e., temperature at which the stiff, highly viscous gel of the dilutable concentrate transitions to a thin, relatively non-viscous liquid) at a temperature above room temperature, preferably in a range of about 35 to about 55° C., preferably in a range of about 40 to about 50° C., and most preferably in a range of about 40 to about 45° C., so that the gel concentrate easily and quickly dissolves/mixes/dilutes with moderately warm to hot water upon addition thereto.

The dilutable high viscosity cleaner gel concentrates are comprised of ingredients as set forth in Table 1 below. The dilutable cleaner gel concentrate is based on a total of 100 wt. %. Accordingly, the ingredients are selected to equal 100 wt. %.

TABLE 1

| wt. % | Ingredient |
|---|---|
| 10-50 | Primary Surfactant - Highly ethoxylated alcohol |
| | ether(s) or polyethoxylated alcohol(s) |
| 0-15 | Secondary Surfactant(s) |
| 0-5 | Rheology-modifying agent(s) |
| 0-5 | Fragrance(s) |
| 0-5 | Acid(s) |
| 0-5 | Alkaline agent(s) |
| 0-5 | Antimicrobial agent(s) |
| 0-0.1 | Water-soluble dye(s) |
| 0-1 | Preservative agent(s) |
| 0-1 | Enzymatic agent(s) |
| 0-5 | Bleaching agent(s) |
| 0-5 | Detergency builder(s) |
| q.s. | Water |

The primary surfactant(s) are one or more surfactants selected from highly ethoxylated alcohol ethers and polyethoxylated alcohols, RO(CH₂CH₂O)ₓH wherein R is an oleyl radical (C₁₈H₃₅) or an alkyl radical C_{y}H_{2y+1}, wherein y≧10 and wherein the degree of ethoxylation x≧15. Preferably, these primary surfactants contain alcohols of 10 to 22 (more preferably 16 to 22) carbon atoms or mixtures thereof. More preferably, the primary surfactants comprise a mixture of C₁₆ to C₁₈ alkyl ethoxylate or oleyl alcohol ethoxylate with from about 20 to about 75 ethylene oxide units or ethoxy groups (EO), preferably from about 20 to about 30 EO. The primary surfactant(s) is the major surfactant component of the surfactant system in the gel concentrate and serves as both a cleaning agent and a gelling agent.

The secondary surfactant can be selected from nonionic, anionic, cationic, zwitterionic and amphoteric surfactants. Preferably, the secondary surfactant is one or more of an alcohol ethoxylate which is different from the primary surfactant described above, anionic alkyl aryl sulfonate, alkyl sulfonate, alkyl sulfate, alkyl ether sulfate, and alkyl dimethyl amine oxide. Preferred secondary surfactants are nonionic alcohol ethoxylates, preferably C₁₀ to C₁₈ ethoxylated alcohols having about 4 to 12 ethoxy (EO) groups. More preferred are nonionic alcohol ethoxylate surfactants having branched chain C₁₀ to C₁₄ alkyl residuals and 4 to 12 ethoxy (EO) groups, and oleyl alcohol ethoxylates having 4 to 12 ethoxy (EO) groups. The secondary surfactants are the minor component of the surfactant system forming the dilutable cleaner gel concentrate. The secondary surfactant serves as both a cleaning agent and a gelling agent.

The rheology-modifying agent component of the gel concentrate serves to reduce the gel temperature and/or viscosity of the gel. Agents suitable for this purpose include (but are not limited to) organic solvents, various water-soluble polymers, and inorganic salts. Preferred organic solvents include various alcohols, glycols, and glycol ethers. Preferred water-soluble polymers include polyethylene glycol (PEG) of various molecular weights. Preferred salts include alkali metal chlorides, alkali metal sulfates, magnesium chloride, magnesium sulfate, and alkali metal salts of fully or partially neutralized organocarboxylic acids. Especially preferred salts include sodium chloride, and trisodium citrate.

The acid component of the gel concentrate can be one or more of various acids. Acids suitable for use include formic acid, acetic acid, propanoic acid, benzoic acid, phthalic acid, malonic acid, succinic acid, oxalic acid, glycolic acid, lactic acid, gluconic acid, glucoheptanoic acid, malic acid, citric acid, homo- and co-polymers of acrylic acid, homo- and co-polymers of maleic acid, aminocarboxylic acid chelants (such as ethylenediaminetetraacetic acid (EDTA), nitrilotriacetic acid (NTA), hydroxyethylethylenediaminetriacetic acid (HEDTA), iminodiamine acid (IDA) and the like), and various amino phosphonic acid chelants. The acid component serves as a cleaning agent by removing hard water deposits, and serves as a water conditioner.

The alkaline agent of the gel concentrate can be one or more of alkali metal and alkaline earth hydroxides; alkali metal or alkaline earth oxides; alkali metal salts of any of carbonates, bicarbonates, phosphates, borates, silicates, and aluminates; ammonia; ethanolamines; and isopropanol amines; as well as fully or partially neutralized salts of organocarboxylic acids, homo- and co-polymers of acrylic acid, homo- and co-polymers of maleic acid, aminocarboxylic acids and aminophosphonic acid chelants. The alkaline agent component serves as a cleaning agent by aiding in the removal of various soils, as well as a water conditioner and detergency builder.

The antimicrobial agent of the gel concentrate can be various materials conventionally known for such use. Preferred antimicrobial materials include quaternary ammonium compounds, phenolic compounds, and hydrogen peroxide. Hydrogen peroxide is also a preferred bleaching agent in the inventive composition.

Various dyes acting as a colorant, preservative agent and enzymatic agents are suitable for inclusion in the dilutable high viscosity cleaner gel concentrate as conventionally known in the art for inclusion in a cleaning composition. Enzymatic agents are useful as a cleaning agent through the breaking down of soil.

Preferred examples of dilutable high viscosity cleaner gel concentrates are set forth in Table 2 below.

TABLE 2
Representative Gel Formulations A-F

| Ingredient | A | B | C | D | E | F |
|---|---|---|---|---|---|---|
| Genapol T 250 | 21.50 | 19.50 | 0.00 | 0.00 | 16.50 | 19.34 |
| Genapol T-680 | 0.00 | 0.00 | 0.00 | 12.00 | 0.00 | 0.00 |
| Genapol O-200 | 0.00 | 0.00 | 26.00 | 0.00 | 0.00 | 0.00 |
| Genapol X-100 | 4.60 | 0.00 | 0.00 | 0.00 | 0.00 | 0.00 |
| Genapol X-060 | 0.00 | 4.80 | 0.00 | 8.00 | 3.00 | 4.76 |
| Brij O50 | 0.00 | 0.00 | 0.00 | 0.00 | 3.00 | 0.00 |
| Fragrance | 3.50 | 4.00 | 4.00 | 3.00 | 3.80 | 3.97 |
| TriSodium Citrate Dihydrate | 0.00 | 0.00 | 0.00 | 0.00 | 0.00 | 0.80 |
| PEG 1500 | 4.00 | 1.75 | 0.00 | 0.00 | 0.00 | 1.49 |
| Citric Acid | 3.00 | 0.00 | 0.00 | 0.00 | 0.00 | 0.00 |
| FD&C Yellow # 5 Dye | 0.0075 | 0.00 | 0.00 | 0.00 | 0.00 | 0.00 |
| Acid Blue # 9 Dye | 0.0060 | 0.00 | 0.00 | 0.00 | 0.00 | 0.00 |
| Proxel GXL Solution | 0.00 | 0.10 | 0.00 | 0.00 | 0.00 | 0.10 |
| Deionized Water | To 100% | To 100% | To 100% | To 100% | To 100% | To 100% |
| Viscosity at 25° C. (Pa-s) | 89 | 107 | 127 | 87 | 87 | 93 |
| Gel Point (° C.) | 42.4 | 47.9 | 44.6 | 48.3 | 45.1 | 40.9 |

Genapol T-250 = Clariant Corp., cetyl/stearyl alcohol ethoxylate, 25 mol EO.
Genapol T-680 = Clariant Corp., cetyl/stearyl alcohol ethoxylate, 65 mol EO.
Genapol O-200 = Clariant Corp., oleyl alcohol ethoxylate, 20 mol EO.
Genapol X-100 = Clariant Corp., iso-tridecyl alcohol ethoxylate, 10 mol EO.
Genapol X-060 = Clariant Corp., iso-tridecyl alcohol ethoxylate, 6 mol EO.
Brij O50 = Croda Corp., oleyl alcohol ethoxylate, 5 mol EO.
Proxel GXL = Lonza Corp., 20% solution of 1,2-benzisothiazolin-3-one in water/dipropylene glycol.
PEG 1500 = Polyethylene glycol, average MW = 1500.

Compositions A-F can be packaged in 2.0 inch diameter medium density polyethylene plastic “squeeze-dispense” tubes fitted with 0.125″ orifice dispensing caps. These gels can be readily dispensed/squeezed from the tubes by hand.

As set forth above, the high viscosity gel concentrate easily dissolves/mixes/dilutes with moderately warm to hot water upon addition thereto. The manner of dissolving/mixing/diluting the gel concentrate in use can be varied. For example, the gel concentrate can be placed into an amount of water in a container (e.g., bucket) to prepare a solution that is then applied by a desired applicator, e.g., a sponge, mop, towel or the like, to a desired surface to be cleaned. Alternatively, for example, the gel concentrate can be placed on an applicator, such as a sponge, towel, mop head or the like, directly and diluted upon being added to water applied to the applicator and/or surface to be or being cleaned, for further spreading of the cleaning composition and/or for rinsing of the composition from the surface being cleaned. The latter example, allows for the initial application of a more concentrated cleaner, than the former example to address more difficult cleaning situations or smaller area cleaning jobs. The above are preferred methods of applying/rinsing the cleaning composition described herein, however, further variations are also possible.

Exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A method of preparing a cleaning solution from a cleaning gel concentrate comprising
(A) providing a cleaning gel concentrate comprising
(1) about 10 to about 50 wt. % of at least one primary surfactant selected from the group consisting of ethoxylated alcohol ethers or polyethoxylated alcohols having a formula RO(CH₂CH₂O)ₓH, wherein R is an alkyl radical of (i) C_{y}H_{2y+1} where y≧10 or (ii) an oleyl radical, and x≧15;
(2) 0 to about 15 wt. % of at least one secondary surfactant comprising one or more of an alcohol ethoxylate different from the primary surfactant, an alkyl aryl sulfonate, alkyl sulfonate, alkyl sulfate, alkyl ether sulfate, and alkyl dimethyl amine oxide;
(3) 0 to 5 wt. % of one or more rheology-modifying agent;
(4) 0 to about 10 wt. % of one or more fragrance;
(5) 0 to about 5 wt. % of one or more acid;
(6) 0 to about 5 wt. % of one or more alkaline agent;
(7) 0 to about 5 wt. % of one or more antimicrobial agent;
(8) 0 to about 0.1 wt. % of one or more water-soluble dye;
(9) 0 to about 1 wt. % of one or more preservative agent;
(10) 0 to about 5 wt. % of one or more bleaching agent;
(11) 0 to about 5 wt. % of one or more detergency builder;
(12) 0 to about 5 wt. % of one or more cleaning solvent;
(13) 0 to about 5 wt. % of one or more salt;
(14) 0 to about 1 wt. % of one or more enzyme; and
(15) a balance of water;
wherein said cleaning gel concentrate has a viscosity of about 50,000 to about 5,000,000 centipoise (cP) at approximately 25° C.;
wherein said primary surfactant and said secondary surfactant provide a surfactant system providing said cleaning gel concentrate with a gel point in a range of about 35° C. to about 55° C.;
(B) combining said cleaning gel concentrate and a quantity of water in a ratio of said cleaning gel concentrate to said water of 1:10 to 1:2000 based on wt. %, wherein said water is at a temperature greater than the gel point of the cleaning gel concentrate and is sufficient in said quantity and said temperature to convert said cleaning gel concentrate from said viscosity of said cleaning gel concentrate to a liquid having a consistency which mixes with said water to provide an aqueous cleaning solution in which said liquid and said water are uniformly dispersed.

2. A cleaning concentrate product comprising
(A) a cleaning concentrate composition in gel form comprising
(1) about 10 to about 50 wt. % of at least one primary surfactant selected from the group consisting of ethoxylated alcohol ethers or polyethoxylated alcohols having a formula RO(CH₂CH₂O)ₓH, wherein R is an alkyl radical of (i) C_{y}H_{2y+1} where y≧10 or (ii) an oleyl radical, and x≧15;
(2) 0 to about 15 wt. % of at least one secondary surfactant comprising one or more of an alcohol ethoxylate different from the primary surfactant, an alkyl aryl sulfonate, alkyl sulfonate, alkyl sulfate, alkyl ether sulfate, and alkyl dimethyl amine oxide;
(3) 0 to 5 wt. % of one or more rheology-modifying agent;
(4) 0 to about 5 wt. % of one or more fragrance;
(5) 0 to about 5 wt. % of one or more acid;
(6) 0 to about 5 wt. % of one or more alkaline agent;
(7) 0 to about 5 wt. % of one or more antimicrobial agent;
(8) 0 to about 0.1 wt. % of one or more water-soluble dye;
(9) 0 to about 1 wt. % of one or more preservative agent;
(10) 0 to about 5 wt. % of one or more bleaching agent;
(11) 0 to about 5 wt. % of one or more detergency builder;
(12) 0 to about 5 wt. % of one or more cleaning solvent;
(13) 0 to about 5 wt. % of one or more salt;
(14) 0 to about 1 wt. % of one or more enzyme; and
(15) a balance of water;
wherein said cleaning concentrate composition has a viscosity of about 50,000 to about 5,000,000 centipoise (cP) at approximately 25° C.;
wherein said primary surfactant and said secondary surfactant provide a surfactant system providing said cleaning concentrate composition with a gel point in a range of about 35° C. to about 55° C.; and
wherein said cleaning concentrate composition is structured to transition to a liquid when combined with water having a temperature equal to or greater than the gel point of the cleaning concentrate composition; and
(B) a squeezable dispensing package containing said cleaning concentrate composition, wherein said composition is sufficiently shear thinning at room temperature to flow from said package upon application of manual pressure to exterior walls of said package.

3. A cleaning concentrate product comprising
(A) a cleaning concentrate composition in gel form comprising
(1) about 10 to about 50 wt. % of at least one primary surfactant selected from the group consisting of ethoxylated alcohol ethers or polyethoxylated alcohols having a formula RO(CH₂CH₂O)ₓH, wherein R is an alkyl radical of (i) C_{y}H_{2y+1} where y≧10 or (ii) an oleyl radical, and x≧15;
(2) 0 to about 15 wt. % of at least one secondary surfactant comprising one or more of an alcohol ethoxylate different from the primary surfactant, an alkyl aryl sulfonate, alkyl sulfonate, alkyl sulfate, alkyl ether sulfate, and alkyl dimethyl amine oxide;
(3) 0 to about 5 wt. % of one or more rheology-modifying agent;
(4) 0 to about 5 wt. % of one or more fragrance;
(5) 0 to about 5 wt. % of one or more acid;
(6) 0 to about 5 wt. % of one or more alkaline agent;
(7) 0 to about 5 wt. % of one or more antimicrobial agent;
(8) 0 to about 0.1 wt. % of one or more water-soluble dye;
(9) 0 to about 1 wt. % of one or more preservative agent;
(10) 0 to about 5 wt. % of one or more bleaching agent;
(11) 0 to about 5 wt. % of one or more detergency builder;
(12) 0 to about 5 wt. % of one or more cleaning solvent;
(13) 0 to about 5 wt. % of one or more salt;
(14) 0 to about 1 wt. % of one or more enzyme; and
(15) a balance of water;
wherein said cleaning concentrate composition has a viscosity of about 50,000 to about 5,000,000 centipoise (cP) at approximately 25° C.;
wherein said primary surfactant and said secondary surfactant provide a surfactant system providing said cleaning concentrate composition with a gel point in a range of about 35° C. to about 55° C.; and
wherein said cleaning concentrate composition is structured to transition to a liquid when combined with water having a temperature equal to or greater than the gel point of the cleaning concentrate composition; and
(B) a water-soluble dispensing package containing said cleaning concentrate composition, wherein said dispensing package is constructed so that when said dispensing package is placed in water having said temperature equal to or greater than the gel point of the cleaning concentrate composition and dissolves, said cleaning concentrate composition transitions to said liquid for mixing with the water to form an aqueous-based solution.

4. The method of claim 1, wherein y=10-22.

5. The method of claim 1, wherein said primary surfactant is a mixture of said ethoxylated alcohol ethers or said polyethoxylated alcohols, and wherein y is a mixture of 16-22 in said alkyl radical, and wherein x is about 20 to about 75.

6. The method of claim 1, wherein said primary surfactant is a mixture of said ethoxylated alcohol ethers or said polyethoxylated alcohols, and wherein y is a mixture of 16-18 in said alkyl radical, and wherein x is about 20 to about 30.

7. The method of claim 1, wherein said primary surfactant is present in an amount of about 15 to about 30 wt. %.

8. The method of claim 1, wherein said acid is one or more of formic acid, acetic acid, propanoic acid, benzoic acid, phthalic acid, malonic acid, succinic acid, oxalic acid, glycolic acid, lactic acid, gluconic acid, glucoheptanoic acid, malic acid, citric acid, homo- and co-polymers of acrylic acid, homo- and co-polymers of maleic acid, aminocarboxylic acid chelants, and amino phosphonic acid chelants.

9. The method of claim 1, wherein said alkaline agent is one or more of alkali metal hydroxides; alkaline earth hydroxides; alkali metal oxides; alkaline earth oxides; alkali metal salts of carbonates; alkali metal salts of bicarbonates; alkali metal salts of phosphates; alkali metal salts of borates; alkali metal salts of silicates; alkali metal salts of aluminates; ammonia; ethanolamines; isopropanolamines; neutralized salts of homo- and co-polymers of acrylic acid; neutralized salts of homo- and co-polymers of maleic acid; neutralized salts of amino carboxylic acids; and neutralized salts of amino phosphonic acids.

10. The method of claim 1, wherein said gel point is about 40° C. to about 50° C.

11. The method of claim 1, wherein said gel point is about 40° C. to about 45° C.

12. The method according to claim 1, wherein said temperature of the water in (B) is about equal to or greater than 35° C.

13. The method of claim 1, wherein said temperature of the water in (B) is about 40° C. to about 50° C.

14. The method of claim 1, further comprising packaging said cleaning gel concentrate in a squeeze tube and wherein said cleaning gel concentrate is sufficiently shear thinning at room temperature to allow the cleaning gel concentrate to flow from the tube upon squeezing said tube.

15. The method of claim 1, wherein said cleaning gel concentrate comprises said primary surfactant and said secondary surfactant, and wherein said secondary surfactant is said alcohol ethoxylate.

16. The method of claim 1, wherein said secondary surfactant is more than one of said alcohol ethoxylate different from the primary surfactant, and wherein said alcohol ethoxylate different from the primary surfactant has (i) an alkyl radical with 10 to 18 carbon atoms, and (ii) about 4 to about 12 ethylene oxide units.

17. The method of claim 1, wherein said secondary surfactant is selected from the group consisting of (a) more than one of said alcohol ethoxylate different from the primary surfactant, and wherein said alcohol ethoxylate different from the primary surfactant has (i) a branched alkyl radical with 10 to 14 carbon atoms, and (ii) about 4 to about 12 ethylene oxide units, and (b) oleyl alcohol ethoxylates having about 4 to about 12 ethylene oxide units.

18. The concentrate product of claim 2, wherein y=10-22.

19. The concentrate product of claim 2, wherein said primary surfactant is a mixture of said ethoxylated alcohol ethers or said polyethoxylated alcohols, and wherein y is a mixture of 16 to 18 in said alkyl radical, and wherein x is about 20 to about 75.

20. The concentrate product of claim 2, wherein said primary surfactant is a mixture of said ethoxylated alcohol ethers or said polyethoxylated alcohols, and wherein y is a mixture of 16 to 18 in said alkyl radical, and wherein x is about 20 to about 30.

21. The concentrate product of claim 2, wherein said primary surfactant is present in an amount of about 15 to about 30 wt. %.

22. The concentrate product of claim 2, wherein said acid is one or more of formic acid, acetic acid, propanoic acid, benzoic acid, phthalic acid, malonic acid, succinic acid, oxalic acid, glycolic acid, lactic acid, gluconic acid, glucoheptanoic acid, malic acid, citric acid, homo- and co-polymers of acrylic acid, homo- and co-polymers of maleic acid, aminocarboxylic acid chelants, and amino phosphonic acid chelants.

23. The concentrate product of claim 2, wherein said alkaline agent is one or more of alkali metal hydroxides; alkaline earth hydroxides; alkali metal oxides; alkaline earth oxides; alkali metal salts of carbonates; alkali metal salts of bicarbonates; alkali metal salts of phosphates; borates; silicates; aluminates; ammonia; ethanolamines; isopropanolamines; neutralized salts of acrylic acid; neutralized salts of maleic acid; neutralized salts of amino carboxylic acids; and neutralized salts of amino phosphoric acids.

24. The concentrate product of claim 2, wherein said gel point is about 40° C. to about 50° C.

25. The concentrate product of claim 2, wherein said gel point is about 40° C. to about 45° C.

26. The concentrate product of claim 2, wherein said temperature of the water in (B) is about equal to or greater than 35° C.

27. The concentrate product of claim 2, wherein said temperature of the water in (B) is about 40° C. to about 50° C.

28. The concentrate product of claim 2, wherein said cleaning concentrate composition includes said primary surfactant and said second surfactant, and wherein said secondary surfactant is one or more nonionic alcohol ethoxylate surfactant having (i) an alkyl radical with 10 to 18 carbon atoms, and (ii) about 4 to about 12 ethylene oxide units.

29. The concentrate product of claim 2, wherein said cleaning concentrate composition includes said primary surfactant and said secondary surfactant, and wherein said secondary surfactant is selected from the group consisting of (a) one or more nonionic alcohol ethoxylate surfactant having (i) a branched chain alkyl radical having 10 to 14 carbon atoms, and (ii) about 4 to about 12 ethylene oxide units and (b) oleyl alcohol ethoxylates having about 4 to about 12 ethylene oxide units.
